(19) United States
(12) Patent Application Publication
(10) Pub. No.: US 2009/0322722 A1
(43) Pub. Date: Dec. 31, 2009

(54) Display device, a method of driving the same, and electronic apparatus including the same

(75) Inventors: Naobumi Toyomura, Kanagawa (JP); Katsuhide Uchino, Kanagawa (JP); Tetsuro Yamamoto, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/457,361

(22) Filed: Jun. 9, 2009

(30) Foreign Application Priority Data
Jun. 30, 2008 (JP) 2008-171825

(51) Int. Cl. G09G 5/00

(52) U.S. Cl. 345/210

(57) ABSTRACT

Disclosed herein is a display device, including a display portion including a plurality of first wirings and a plurality of second wirings each disposed in rows, respectively, a plurality of third wirings disposed in columns, respectively, and a plurality of light emitting elements and a plurality of pixel circuits each disposed in a matrix, a first drive portion for successively applying a selection pulse containing a first voltage, a second voltage and a third voltage to the plurality of first wirings, a second drive portion for successively applying a current control pulse in accordance with which a transient current is caused to flow through the pixel circuit to the plurality of second wirings, and a third drive portion for applying a signal pulse containing a signal potential corresponding to a video signal to each of the plurality of third wirings.

### BACKGROUND OF THE INVENTION

1. Field of the Invention

The present invention relates to a display device including a display portion having a light emitting element and a pixel circuit every pixel, and a drive portion for driving the pixel circuits, a method of driving the same, and an electronic apparatus including the same.

2. Description of the Related Art

In recent years, in a field of a display device for displaying thereon an image, a display device using a current drive type optical element an emission luminance of which changes depending on a value of a current caused to flow therethrough, for example, an organic electro luminescence (EL) element has been developed and commercial realization thereof has been promoted.

Unlike a liquid crystal element or the like, the organic EL element is a self light emission element. For this reason, since a light source (backlight) needs not to be provided in a display device using the organic EL element (organic EL display device), the organic EL display device has high visibility, less power consumption, and a high response speed of an element as compared with the case of a liquid crystal display device including the light source.

Similarly to the case of the liquid crystal display device, a passive matrix system and an active matrix system are known as a system for driving the organic EL display device. Although the former has a simple structure, the former involves a problem that it is difficult to realize a large-scaled display device having high definition, and so forth. For this reason, at present, the organic EL display devices each utilizing the active matrix system have been actively developed. In the active matrix system, a current caused to flow through a light emitting element disposed every pixel is controlled by an active element (in general, a Thin Film Transistor (TFT)) provided within a drive circuit provided every light emitting element.

Now, in general, current-voltage (I-V) characteristics of the organic EL element deteriorates with time (temporally deteriorates). When the I-V characteristics of the organic EL element temporally changes, in a pixel circuit for current-driving the organic EL element, a voltage division ratio between the organic EL element, and a drive transistor connected in series with the organic EL element changes accordingly. Therefore, a gate-to-source voltage V_{gs} of the drive transistor also changes. As a result, since a value of a current caused to flow through the drive transistor, a value of a current caused to flow through the organic EL element also changes, and an emission luminance also changes depending on the value of the current caused to flow through the organic EL element.

In addition, a threshold voltage Vₜₕ and a mobility μ of the drive transistor temporally change, or the threshold voltage Vₜₕ and the mobility μ of the drive transistor differ every pixel circuit due to a dispersion of manufacture processes in some cases. When the threshold voltage Vₜₕ and the mobility μ of the drive transistor differ every pixel circuit, the value of the current caused to flow through the drive transistor disperses every pixel circuit. Therefore, even when the same voltage is applied to gate electrodes of the drive transistors, the emission luminances of the organic EL elements disperse, and thus uniformity of a picture is impaired.

In order to cope with this situation, even when the I-V characteristics of the organic EL element temporally change, or the threshold voltage Vₜₕ and the mobility μ of the drive transistor temporally change, the emission luminance of the organic EL element has to be held constant without being influenced by these temporal changes. Accordingly, a display device is developed in which a function of compensating for the change in I-V characteristics of the organic EL element, and a function of correcting the changes in threshold voltage Vₜₕ and mobility μ of the drive transistor are incorporated. This technique, for example, is disclosed in Japanese Patent Laid-Open No. 2008-083272.

FIG. 13 shows a schematic configuration of the display device disclosed in Patent Document 1. The display device 100 shown in FIG. 13 includes a display portion 110 in which a plurality of pixels 111 are displayed in a matrix, and a drive portion (having a horizontal drive circuit 120, a write scanning circuit 130 and a power source scanning circuit 140) for driving the pixels 111.

Each of the pixels 111 is composed of a pixel 111R for a red color, a pixel 111G for a green color, and a pixel 111B for a blue color. As shown in FIG. 14, each of the pixel 111R for the red color, the pixel 111G for the green color, and the pixel 111B for the blue color is composed of an organic EL element 112 (an organic EL element 112R, 112G or 112B), and a pixel circuit 113 connected to the organic EL element 112. The pixel circuit 113 is composed of a sampling transistor T_{WS}, a hold capacitor C_{S}, and a drive transistor T_{Dr}, and thus has a 2Tr1C-circuit configuration. A gate line WSL drawn from the write scanning circuit 130 is formed so as to extend in a row direction to be connected to a gate electrode of the sampling transistor T_{WS}. A drain line DSL drawn from the power source scanning circuit 140 is also formed so as to extend in the row direction to be connected to a drain electrode of the drive transistor T_{Dr}. In addition, a signal line DTL drawn from the horizontal drive circuit 120 is formed so as to extend in a column direction to be connected to a drain electrode of the sampling transistor T_{WS}. A source electrode of the sampling transistor T_{WS} is connected to each of a gate electrode of the drive transistor T_{Dr}, and one terminal of the hold capacitor C_{S}. Also, each of a source electrode of the drive transistor T_{Dr}, and the other terminal of the hold capacitor Cₛ is connected to an anode electrode of the organic EL element 112R, 112G or 112B (hereinafter referred to as “the organic EL element 112R or the like”). A cathode electrode of the organic EL element 112R or the like is connected to a ground line GND.

FIGS. 15A to 15E respectively show various kinds of waveforms of the potentials in the display device 100 shown in FIG. 11. Also, FIGS. 15A to 15E show a situation in which two kinds of voltages (Vₒₙ and V_{off} (<Vₒₙ)) are applied to the gate line WSL, two kinds of voltage (V_{cc} and Vᵢₙᵢ (<V_{cc})) are applied to the drain line DSL, and two kinds of voltages (V_{sig} and V_{ofs}) are applied to the signal line DTL. Moreover, FIGS. 15A to 15E show a situation in which a gate voltage V_{g} and a source voltage Vₛ of the drive transistor T_{Dr} momentarily change in accordance with application of the voltages to the gate line WSL, the drain line DSL and the signal line DTL.

### (Time Period for Preparation for Vₜₕ Correction)

Firstly, an operation for preparing for correction for the threshold voltage Vₜₕ is carried out. Specifically, the power source scanning circuit 140 causes the voltage of the drain line DSL to drop from the voltage V_{cc} to the voltage Vᵢₙᵢ (time T₁). As a result, the source voltage Vₛ becomes equal to the voltage Vᵢₙᵢ, thereby quenching the organic EL element 112 or the like. Next, while the voltage of the drain line DSL is held at the voltage Vᵢₙᵢ after the horizontal drive circuit 120 switches the voltage of the signal line DTL from the voltage V_{sig} over to the voltage V_{ofs}, the write scanning circuit 130 causes the voltage of the gate line WSL to rise from the voltage V_{off} to the voltage V_{of} (time T₂). As a result, the gate voltage V_{g} drops to the voltage V_{ofs}.

### (Time Period for First Vₜₕ Correction)

Next, an operation for correcting the threshold voltage Vₜₕ is carried out. Specifically, while the voltage of the signal line DTL is held at the voltage V_{ofs}, the power source scanning circuit 140 causes the voltage of the drain line DSL to rise from the voltage Vᵢₙᵢ to the voltage V_{cc} (time T₃). As a result, a current I_{ds} is caused to flow between the drain and the source of the drive transistor T_{Dr}, so that the source voltage Vₛ rises. After that, the write scanning circuit 130 causes the voltage of the gate line WSL to drop from the voltage Vₒₙ to the voltage V_{off} (time T₄) before the horizontal drive circuit 120 switches the voltage of the signal line DTL from the voltage V_{ofs} over to the voltage V_{sig}. As a result, the gate voltage V_{g} of the drive transistor T_{Dr} becomes a floating state, and thus the connection for the threshold voltage Vₜₕ of the drive transistor T_{Dr} is temporarily stopped.

### (Pausing Time Period for First Vₜₕ Correction)

For a time period for pausing of the connection for the threshold voltage Vₜₕ of the drive transistor T_{Dr}, an operation for sampling the voltage of the signal line DTL is carried out in another row (pixels) different from the row (pixels) for which the last correction for the threshold voltage Vₜₕ of the drive transistor T_{Dr} is carried out. It is noted that when the connection for the threshold voltage Vₜₕ is insufficient, that is, a gate-to-source potential difference V_{gs} of the drive transistor T_{Dr} is larger than the threshold voltage Vₜₕ of the drive transistor T_{Dr}, the current I_{ds} is caused to flow between the drain and the source of the drive transistor T_{Dr} in the row (pixels) for which the last correction for the threshold voltage Vₜₕ is carried out for the time period as well for the pausing of the correction for the threshold voltage Vₜₕ. As a result, the source voltage Vₛ of the drive transistor T_{Dr} rises, and the gate voltage V_{g} thereof also rises through coupling via the hold capacitor Cₛ.

### (Time Period for Second Vₜₕ Correction)

After the time period for the pausing of the correction for the threshold voltage Vₜₕ ends, the operation for correcting the threshold voltage Vₜₕ is carried out again. Specifically, when the voltage of the signal line DTL is equal to voltage V_{ofs}, and thus the correction for the threshold voltage Vₜₕ is possible, the write scanning circuit 130 causes the voltage of the gate line WSL to rise from the voltage V_{off} to the voltage Vₒₙ (time T₅) to connect the gate electrode of the drive transistor T_{Dr} to the signal line DTL. At this time, when the source voltage Vₛ of the drive transistor T_{Dr} is lower than (V_{ofs}−Vₜₕ) (when the operation for correcting the threshold voltage Vₜₕ is not yet completed), the current I_{ds} is continuously caused to flow between the drain and the source of the drive transistor T_{Dr} until the drive transistor T_{Dr} is cut off (until the potential difference V_{gs} becomes equal to the threshold voltage Vₜₕ). As a result, the hold capacitor Cₛ is charged with the electricity from the threshold voltage Vₜₕ, and the potential difference V_{gs} becomes equal to the threshold voltage Vₜₕ. After that, the write scanning circuit 130 causes the voltage of the gate line WSL to drop from the voltage Vₒₙ to the voltage V_{off} (time T₆) before the horizontal drive circuit 120 switches the voltage of the signal line DTL from the voltage V_{ofs} to the voltage V_{sig}. As a result, since the gate voltage V_{g} of the drive transistor T_{Dr} becomes the floating state, the potential difference V_{gs} can be maintained at the threshold voltage Vₜₕ irrespective of the magnitude of the voltage of the signal line DTL. Setting the potential difference V_{gs} at the threshold voltage Vₜₕ in such a manner can prevent the emission luminances of the organic EL elements 112 or the like from dispersing even when the threshold voltage Vₜₕ of the drive transistor T_{Dr} disperses every pixel circuit 122.

### (Pausing Time Period for Second Vₜₕ Correction)

After that, for the time period for the pausing of the correction for the threshold voltage Vₜₕ, the horizontal drive circuit 120 switches the voltage of the signal line DTL from the voltage V_{ofs} over to the voltage V_{sig}.

### (Time Period for Write·μ Correction)

A write operation and an operation for correcting the mobility μ are carried out after the time period for the pausing of the correction for the threshold voltage Vₜₕ ends. Specifically, while the voltage of the signal line DTL is held at the voltage V_{sig}, the write scanning circuit 130 causes the voltage of the gate line WSL to rise from the voltage V_{off} to the voltage Vₒₙ (time T₇), thereby connecting the gate electrode of the drive transistor T_{Dr} to the signal line DTL. As a result, the gate voltage of the drive transistor T_{Dr} becomes equal to the voltage V_{sig}. At this time, the anode voltage of the organic EL element 112R or the like is still smaller than a threshold voltage Vₑₗ of the organic EL element 112R or the like in this stage, and thus the organic EL element 112R or the like is cut off. For this reason, the current I_{ds} is caused to flow through an element capacitor (not shown) of the organic EL element 112R or the like to charge the element capacitor with the electricity. As a result, the source voltage Vₛ rises by ΔV and the potential difference V_{gs} soon becomes equal to (V_{sig}+Vₜₕ−ΔV). The operation for correcting the mobility μ is carried out concurrently with the write operation in such a manner. Here, ΔV becomes large as the mobility μ of the drive transistor T_{Dr} is larger. Thus, the potential difference V_{gs} is reduced by ΔV before the light emission, thereby making it possible to remove the dispersion of the mobility μ for each pixel.

### (Light Emission)

Finally, the write scanning circuit 130 causes the voltage of the gate line WSL to drop from the voltage Vₒₙ to the voltage V_{off} (time T₈). As a result, the gate voltage V_{g} of the drive transistor T_{Dr} becomes the floating state, so that the current I_{ds} is caused to flow between the drain and the source of the drive transistor T_{Dr} and thus the source voltage Vₛ rises. As a result, the organic EL element 112R or the like emits a light with a desired luminance.

Now, each of the horizontal drive circuit 120, the write scanning circuit 130 and the power source scanning circuit 140 is basically composed of a shift register (not shown), and includes signal outputting portions (not shown) in respective stages so as to correspond to either the columns or the rows of the pixels 111, respectively. For this reason, when the numbers of columns and rows of the pixels 111 increase, the number of output stages of the shift registers increase all the more because the numbers of signal lines DTLs, drain lines DSLs and gate lines WSLs increase accordingly. This causes the increase in scale of the peripheral circuits of the display portion 110.

In order to cope with this situation, heretofore, the measures to share the output stage of the shift registers, thereby reducing the increasing in scale of the peripheral circuits of the display portion 110 have been taken. For example, a technique disclosed in Japanese Patent Laid-Open No. 2006-251322 (referred to as Patent Document 2 hereinafter) proposes a system with which a plurality of pixels 111 share the signal line DTL. By adopting this system, the reduction in circuit scale, the reduction in circuit area, and the lowering of the circuit cost can be made possible all the more because the output stage of the shift register within the horizontal drive circuit 120 for driving the signal line DTL can be shared among a plurality of pixels.

### SUMMARY OF THE INVENTION

It is described in Patent Document 2 to share the output stage of the shift register within the horizontal drive circuit 120 among a plurality of pixel columns. However, it is important from a viewpoint of enhancement of the cost performance of the display device to share the output stage of the shift register in the write scanning circuit 130 and the power source scanning circuit 140 as well. In particular, for the power source scanning circuit 140, the size of a signal outputting portion has to be made large for the purpose of stabilizing a current supply ability. Therefore, the output stage of the shift register within the power source scanning circuit 140 is shared among a plurality of pixel columns to reduce the number of signal outputting portions, thereby making it possible to effectively realize the low-cost promotion and miniaturization of the display device.

FIG. 16 shows a schematic configuration of a display device 200 in which a signal outputting portion within a power source scanning circuit 140 is shared among a plurality of pixel rows. In the display device 200 shown in FIG. 16, drain lines DSLs (DSL1, DSL2, . . . ) are connected to signal outputting portions within a power source scanning circuit 140, respectively, so as to show one-to-one correspondence. Also, pixels 111 belonging to a plurality of pixel rows (three rows in FIG. 16), respectively, are connected to the respective drain lines DSLs (DSL1, DSL2, . . . ). On the other hand, signal lines DTLs (DSL1, DTL2, . . . ) are connected to signal outputting portions within the horizontal driving circuit 120, respectively, so as to show one-to-one correspondence. Also, the pixels 111 belonging to the respective rows are connected to the signal lines DTLs (DTL1, DTL2, . . . ), respectively, so as to show one-to-one correspondence. In addition, gate lines WSLs (WSL1, WSL2, . . . ) are connected to signal outputting portions within the write scanning circuit 130, respectively, so as to show one-to-one correspondence. Also, the pixels 111 belonging to the respective columns are connected to the gate lines WSLs (WSL1, WSL2, . . . ), respectively, so as to show one-to-one correspondence.

FIGS. 17A to 17H respectively show various kinds of waveforms of potentials in the display device 200 shown in FIG. 16. Also, FIGS. 17A to 17H show a situation in which two kinds of voltages (V_{cc} and Vₛₛ (<V_{cc})) is applied to each of the drain lines DSL1 and DSL2, and two kinds of voltages (Vₒₙ and V_{off} (<Vₒₙ)) are applied to each of the gate lines WSL1 to WSL6. As can be seen from FIGS. 17A to 17H, in the display device 200, a plurality of pixels (three rows in FIGS. 17A to 17H) are set as one group, and the voltages V_{cc} and Vₛₛ are applied at common timings from the drain lines DSLs (DSL1, DSL2, . . . ) to the pixels 111 every group.

FIGS. 18A to 18E respectively show waveforms of the voltages applied to one pixel 111 of the display device 200. Specifically, FIGS. 18A to 18E show a situation in which two kinds of voltages (V_{cc} and Vₛₛ) are applied to the drain line DSL, three kinds of voltages (V_{sig}, Vₑᵣₛ (<Vₑₗ), and V_{ofs} (<Vₑᵣₛ)) are applied to the signal line DTL, and two kinds of voltages (Vₒₙ and V_{off}) are applied to the gate line WSL. Moreover, FIGS. 18A to 18E show a situation in which the gate voltage V_{g} and the source voltage Vₛ of the drive transistor T_{Dr} momentarily change in accordance with application of the voltages to the drain line DSL, the signal line DTL, and the gate line WSL. It should be noted that the voltage Vₑₗ described above is a threshold voltage of the organic EL element 112R or the like.

Since the waveforms shown in FIGS. 18A to 18E are slightly different from those shown in FIGS. 15A to 15E, the waveforms shown in FIGS. 18A to 18E will be described detail hereinafter.

### (Time Period for Quenching)

Firstly, the organic EL element 112R or the like is quenched. Specifically, while the voltage of the drain line DSL is held at the voltage V_{cc}, and the voltage of the signal line DTL is held at the voltage Vₑᵣₛ, the write scanning circuit 130 causes the voltage of the gate line WSL to rise from the voltage V_{off} to the voltage V_{of} (time T₁), thereby connecting the gate electrode of the drive transistor T_{Dr} to the signal line DTL. As a result, the gate voltage V_{g} of the drive transistor T_{Dr} also begins to drop, and the source voltage Vₛ of the drive transistor T_{Dr} begins to drop through the coupling via the hold capacitor Cₛ. After that, when the gate voltage V_{g} becomes equal to the voltage Vₑᵣₛ and the source voltage Vₛ becomes equal to (Vₑₗ+V_{ca}) (V_{ca} is a cathode voltage of the organic EL element 112R or the like), and thus the organic EL element 112R or the like is quenched, the write scanning circuit 130 causes the voltage of the gate line WSL to drop from the voltage Vₒₙ to the voltage V_{off}, thereby making the gate voltage V_{g} of the drive transistor T_{Dr} in the floating state (time T₂).

### (Time Period for Preparation for Vₜₕ Correction)

Next, an operation for preparing for the correction for the threshold voltage Vₜₕ is carried out. Specifically, while the voltage of the gate line WSL is held at the voltage V_{off}, the power source scanning circuit 140 causes the voltage of the drain line DSL to drop from the voltage V_{cc} to the voltage Vₛₛ (time T₃). As a result, when the drain line DSL side of the drive transistor T_{Dr} acts as the source, and thus the current I_{ds} is caused to flow between the drain and the source of the drive transistor T_{Dr}, so that the gate voltage V_{g} becomes equal to (Vₛₛ+Vₜₕ), the flowing of the current I_{ds} stops. At this time, the source voltage Vₛ becomes equal to [Vₑₗ+V_{ca}−{Vₑᵣₛ−(Vₛₛ+Vₜₕ)}] and thus the potential difference V_{gs} becomes smaller than the threshold voltage Vₜₕ.

Subsequently, the power source scanning circuit 140 causes the voltage of the drain line DSL to rise from the voltage Vₛₛ to the voltage V_{cc} (time T4). As a result, the current I_{ds} is caused to flow between the drain and the source of the drive transistor T_{Dr}, and thus each of the gate voltage V_{g} and the source voltage Vₛ rises due to a capacitive coupling between a parasitic capacitance between the gate and the drain of the drive transistor T_{Dr}, and the hold capacitor Cₛ. At this time, the potential difference V_{gs} is still smaller than the threshold voltage Vₜₕ.

### (Time Period for First Vₜₕ Correction)

Next, an operation for correcting the threshold voltage Vₜₕ is carried out. Specifically, while the voltage of the drain line DSL is held at the voltage V_{cc} and the voltage of the signal line DTL is held at the voltage V_{ofs}, the write scanning circuit 130 causes the voltage of the gate line WSL to rise from the voltage V_{off} to the voltage Vₒₙ (time T₅). As a result, the current I_{ds} is caused to flow between the drain and the source of the drive transistor T_{Dr}, so that each of the gate voltage V_{g} and the source voltage Vₛ rises due to the capacitive coupling between the parasitic capacitance between the gate and the drain of the drive transistor T_{Dr}, and the hold capacitor Cₛ. Here, the potential difference V_{gs} becomes large because the hold capacitance Cₛ is extremely smaller than the element capacitor of the organic EL elements 112R and the like and a rise of the source voltage Vₛ is sufficiently smaller than that of gate voltage V_{g}. Also, in a stage in which the potential difference V_{gs} becomes larger than the threshold voltage Vₜₕ, the write scanning circuit 130 causes the voltage of the gate line WSL to drop from the voltage Vₒₙ to the voltage V_{off} (time T₆). As a result, the gate voltage V_{g} of the drive transistor T_{Dr} becomes the floating state, and thus the operation for correcting the threshold voltage Vₜₕ is temporarily stopped.

### (Time Period for Pausing of First Vₜₕ Correction)

For a time period for pausing of the connection for the threshold voltage Vₜₕ, an operation for sampling the voltage of the signal line DTL is carried out in another row (pixels) different from the row (pixels) for which the last correction for the threshold voltage Vₜₕ is carried out. Note that, at this time, in the row (pixels) for which the last correction for the threshold voltage Vₜₕ is carried out, the source voltage Vₛ is lower than (V_{ofs}−Vₜₕ). Therefore, the current I_{ds} is caused to flow between the drain and the source of the drive transistor T_{Dr} in the row (pixels) for which the last correction for the threshold voltage Vₜₕ is carried out for the time period as well for the pausing of the correction for the threshold voltage Vₜₕ. As a result, the source voltage Vₛ rises, and the gate voltage V_{g} also rises through coupling via the hold capacitor Cₛ.

### (Time Period for Second Vₜₕ Correction)

After the time period for the pausing for the correction for the threshold voltage Vₜₕ ends, the operation for correcting the threshold voltage Vₜₕ is carried out again. Specifically, when the voltage of the signal line DTL is equal to voltage V_{ofs}, and thus the correction for the threshold voltage Vₜₕ is possible, the write scanning circuit 130 causes the voltage of the gate line WSL to rise from the voltage V_{off} to the voltage Vₒₙ (time T₅), thereby connecting the gate electrode of the drive transistor T_{Dr} to the signal line DTL. At this time, when the source voltage Vₛ is lower than (V_{ofs}−Vₜₕ) (when the operation for correcting the threshold voltage Vₜₕ is not yet completed), the current I_{ds} is continuously caused to flow between the drain and the source of the drive transistor T_{Dr} until the drive transistor T_{Dr} is cut off (until the potential difference V_{gs} becomes equal to the threshold voltage Vₜₕ). After that, the write scanning circuit 130 causes the voltage of the gate line WSL to drop from the voltage Vₒₙ to the voltage V_{off} (time T₆) before the horizontal drive circuit 120 switches the voltage of the signal line DTL from the voltage V_{ofs} over to the voltage V_{sig}. As a result, since the gate voltage V_{g} of the drive transistor T_{Dr} becomes the floating state, the potential difference V_{gs} can be maintained at constant irrespective of the magnitude of the voltage of the signal line DTL.

Note that, the operation for correcting the threshold voltage Vₜₕ is completed when for the time period for the correction for the threshold voltage Vₜₕ, the hold capacitor Cₛ is charged with the electricity from the threshold voltage Vₜₕ, so that the potential difference V_{gs} becomes equal to the threshold voltage Vₜₕ. However, when the potential difference V_{gs} does not reach the threshold voltage Vₜₕ, the operation for correcting the threshold voltage Vₜₕ, and the operation for pausing the correction for the threshold voltage Vₜₕ are repetitively carried out until the potential difference V_{gs} reaches the threshold voltage Vₜₕ.

### (Time Period for Write·μ Correction)

A write operation and an operation for correcting the mobility μ are carried out after the time period for the pausing of the correction for the threshold voltage Vₜₕ ends. Specifically, while the voltage of the signal line DTL is held at the voltage V_{sig}, the write scanning circuit 130 causes the voltage of the gate line WSL to rise from the voltage V_{off} to the voltage Vₒₙ (time T₇), thereby connecting the gate electrode of the drive transistor T_{Dr} to the signal line DTL. As a result, the gate voltage of the drive transistor T_{Dr} becomes equal to the voltage V_{sig}. At this time, the anode voltage of the organic EL element 112R or the like is still smaller than a threshold voltage Vₑₗ of the organic EL element 112R or the like in this stage, and thus the organic EL element 112R or the like is cut off. For this reason, the current I_{ds} is caused to flow through an element capacitor (not shown) of the organic EL element 112R or the like to charge the element capacitor with the electricity. As a result, the source voltage Vₛ rises by ΔV and the potential difference V_{gs} soon becomes equal to (V_{sig}+Vₜₕ−ΔV). The operation for correcting the mobility μ is carried out concurrently with the write operation in such a manner.

### (Light Emission)

Finally, the write scanning circuit 130 causes the voltage of the gate line WSL to drop from the voltage Vₒₙ to the voltage V_{off} (time T₈). As a result, the gate voltage V_{g} of the drive transistor T_{Dr} becomes the floating state, so that the current I_{ds} is caused to flow between the drain and the source of the drive transistor T_{Dr} and thus the source voltage Vₛ rises. As a result, the organic EL element 112R or the like emits a light with a desired luminance.

Now, in order that the potential difference V_{gs} of the drive transistor T_{Dr} may exceed the threshold voltage Vₜₕ while the gate voltage V_{g} is held at the voltage V_{ofs} for the time period for the correction for the threshold voltage Vₜₕ, the gate voltage V_{g} of the drive transistor T_{Dr} has to be made sufficiently low before start of the operation for correcting the threshold voltage Vₜₕ. For example, when the gate voltage V_{g} of the drive transistor T_{Dr} right before start of the operation for correcting the threshold voltage Vₜₕ is set at +1 V, in order to perfectly turn OFF the sampling transistor T_{WS} (in order to set the gate-to-source potential difference V_{gs} of the sampling transistor T_{WS} at about −3 V), as shown in FIG. 19A, for the time period for the pausing of the correction for the threshold voltage Vₜₕ, the voltage V_{off} of the gate line WSL has to be set at −2 V. When the voltage V_{off} of the gate line WSL is set at −2 V in such a manner, it is possible to perfectly turn OFF the sampling transistor T_{WS} because the potential difference V_{gs} becomes −3 V, as shown in FIG. 19B, for the time period as well for light emission.

However, it may be impossible to perfectly turn OFF the sampling transistor T_{WS} because the potential difference V_{gs} of the sampling transistor T_{WS} becomes equal to +8 V, as shown in FIG. 19C, for the time period for the preparation for the correction for the threshold voltage Vₜₕ. Thus, a leakage current is caused to flow between the drain and the source of the sampling transistor T_{WS}. As a result, the potential difference V_{gs} of the drive transistor T_{Dr} becomes lower than the threshold voltage Vₜₕ for the time period for the correction for the threshold voltage Vₜₕ in some cases because the gate voltage V_{g} of the drive transistor T_{Dr} right before start of the correction for the threshold voltage Vₜₕ does not become sufficiently low. Therefore, in this case, there is encountered a problem that the threshold voltage Vₜₕ may not be corrected in the subsequent process.

The present invention has been made in the light of the problems described above, and it is therefore desirable to provide a display device in which a potential difference V_{gs} can be prevented from becoming smaller than a threshold voltage Vₜₕ when the threshold voltage Vₜₕ is corrected, a method of driving the same, and an electronic apparatus including the same.

In order to attain the desire described above, according to an embodiment of the present invention, there is provided a display device including: a display portion having a plurality of first wirings and a plurality of second wirings each disposed in rows, respectively, a plurality of third wirings disposed in columns, respectively, and a plurality of light emitting elements and a plurality of pixel circuits each disposed in a matrix; a first drive portion for successively applying a selection pulse containing therein a first voltage, a second voltage and a third voltage to the plurality of first wirings; a second drive portion for successively applying a current control pulse in accordance with which a transient current is caused to flow through the pixel circuit to the plurality of second wirings; and a third drive portion for applying a signal pulse containing therein a signal potential corresponding to a video signal to each of the plurality of third wirings; in which the first voltage, the second voltage and the third voltage contained in the selection pulse have a relationship of the third voltage>the first voltage>the second voltage; the pixel circuit includes a first transistor for sampling the signal pulse, and a second transistor for driving the light emitting element; the first drive portion applies the second voltage to corresponding one of the plurality of first wirings for a time period for which corresponding one of the light emitting elements is quenched and before start of correction for a threshold voltage of corresponding one of the second transistors; and the second drive portion applies the current control pulse to corresponding one of the plurality of second wirings while the first drive portion applies the second voltage to corresponding one of the plurality of first wirings.

According to another embodiment of the present invention, there is provided a method of driving a display device including: a display portion having a plurality of first wirings and a plurality of second wirings each disposed in rows, respectively, a plurality of third wirings disposed in columns, respectively, and a plurality of light emitting elements and a plurality of pixel circuits each disposed in a matrix; a first drive portion for successively applying a selection pulse containing therein a first voltage, a second voltage and a third voltage to the plurality of first wirings; a second drive portion for successively applying a current control pulse in accordance with which a transient current is caused to flow through the pixel circuit to the plurality of second wirings; and a third drive portion for applying a signal pulse containing therein a signal potential corresponding to a video signal to each of the plurality of third wirings; the first voltage, the second voltage and the third voltage contained in the selection pulse having a relationship of the third voltage>the first voltage>the second voltage; the pixel circuit including a first transistor for sampling the signal pulse, and a second transistor for driving the light emitting element; in which the first drive portion is caused to apply the second voltage to corresponding one of the plurality of first wirings for a time period for which corresponding one of the light emitting elements is quenched and before start of correction for a threshold voltage of corresponding one of the second transistors; and the second drive portion is caused to apply the current control pulse to corresponding one of the plurality of second wirings while the first drive portion is caused to apply the second voltage to corresponding one of the plurality of first wirings.

According to still another embodiment of the present invention, there is provided an electronic apparatus including a display device; the display device having: a display portion including a plurality of first wirings and a plurality of second wirings each disposed in rows, respectively, a plurality of third wirings disposed in columns, respectively, and a plurality of light emitting elements and a plurality of pixel circuits each disposed in a matrix; a first drive portion for successively applying a selection pulse containing therein a first voltage, a second voltage and a third voltage to the plurality of first wirings; a second drive portion for successively applying a current control pulse in accordance with which a transient current is caused to flow through the pixel circuit to the plurality of second wirings; and a third drive portion for applying a signal pulse containing therein a signal potential corresponding to a video signal to each of the plurality of third wirings; in which the first voltage, the second voltage and the third voltage contained in the selection pulse have a relationship of the third voltage>the first voltage>the second voltage; the pixel circuit includes a first transistor for sampling the signal pulse, and a second transistor for driving the light emitting element; the first drive portion applies the second voltage to corresponding one of the plurality of first wirings for a time period for which corresponding one of the light emitting elements is quenched and before start of correction for a threshold voltage of corresponding one of the second transistors; and the second drive portion applies the current control pulse to corresponding one of the plurality of second wirings while the first drive portion applies the second voltage to corresponding one of the plurality of first wirings.

In the display device, the method of driving the same, and the electronic apparatus including the same of the present invention, in the step of the preparation for the correction for the threshold voltage, the voltage of the corresponding one of the first wirings is equal to the second voltage lower than the first voltage set in the step of the correction for the threshold voltage light emission. As a result, the potential difference between the gate and the source of the first transistor can be made small as compared with the case where the voltage of the corresponding one of the first wirings is set at the first voltage in the step of the preparation for the correction for the threshold voltage.

According to the display device, the method of driving the same, and the electronic apparatus including the same of the present invention, since in the step of the preparation for the correction for the threshold voltage, the voltage of the corresponding one of the first wirings is set at the second voltage, it is possible to reduce the difference in potential between the gate and the source of the first transistor. As a result, it is possible to reduce a leakage current caused to flow between the drain and the source of the first transistor. Therefore, for example, in the first correction for the threshold voltage within the step of the correction for the threshold voltage light emission, the difference in potential between the gate and the source of the second transistor can be made sufficiently larger than the threshold voltage of the second transistor. As a result, the threshold voltage can be reliably corrected in the subsequent process within the step of the correction for the threshold voltage light emission.

### BRIEF DESCRIPTION OF THE DRAWINGS

FIG. 1 is a block diagram showing a configuration of a display device according to an embodiment of the present invention;

FIG. 2 is a circuit diagram showing an inner configuration of a pixel shown in FIG. 1;

FIGS. 3A to 3H are respectively waveform charts explaining an operation of the display device of the embodiment shown in FIG. 1;

FIGS. 4A to 4E are waveform charts explaining an operation of the pixel shown in FIG. 2;

FIGS. 5A to 5C are respectively circuit diagrams explaining a leakage current of a sampling transistor shown in FIG. 2;

FIG. 6 is a graph showing I-V characteristics of a transistor;

FIG. 7 is a top plan view showing a schematic construction of a module in the form of which the display device of the embodiment is constructed;

FIG. 8 is a perspective view showing an exterior appearance of a television set as a first example of an electronic apparatus according to an embodiment of the present invention;

FIGS. 9A and 9B are respectively a perspective view showing an exterior appearance of a digital camera as a second example of the electronic apparatus of the embodiment when viewed from a front side, and a perspective view showing the exterior appearance of the digital camera as the second example of the electronic apparatus of the embodiment of the embodiment when viewed from a back side;

FIG. 10 is a perspective view showing an exterior appearance of a notebook-size personal computer as a third example of the electronic apparatus of the embodiment;

FIG. 11 is a perspective view showing an exterior appearance of a video camera as a fourth example of the electronic apparatus of the embodiment;

FIGS. 12A to 12G are respectively a front view showing an exterior appearance of a mobile phone as a fifth example of the electronic apparatus of the embodiment in an open state, a side elevational view thereof, a front view thereof in a close state, a left side elevational view thereof, a right side elevational view thereof, a top plan view thereof, and a bottom view thereof;

FIG. 13 is a block diagram showing an example of a configuration of an existing display device;

FIG. 14 is a circuit diagram showing an inner configuration of a pixel shown in FIG. 13;

FIGS. 15A to 15E are respectively waveform charts explaining an operation of the example of the existing display device shown in FIG. 13;

FIG. 16 is a block diagram showing another example of a configuration of an existing display device;

FIGS. 17A to 17H are respectively waveform charts explaining an operation of another example of the existing display device shown in FIG. 16;

FIGS. 18A to 18E are respectively waveform charts explaining an operation of a pixel shown in FIG. 16; and

FIGS. 19A to 19C are respectively circuit diagrams explaining a leakage current in a sampling transistor in another example of the existing display device shown in FIG. 16.

### DETAILED DESCRIPTION OF THE PREFERRED EMBODIMENTS

The preferred embodiments of the present invention will be described in detail hereinafter with reference to the accompanying drawings.

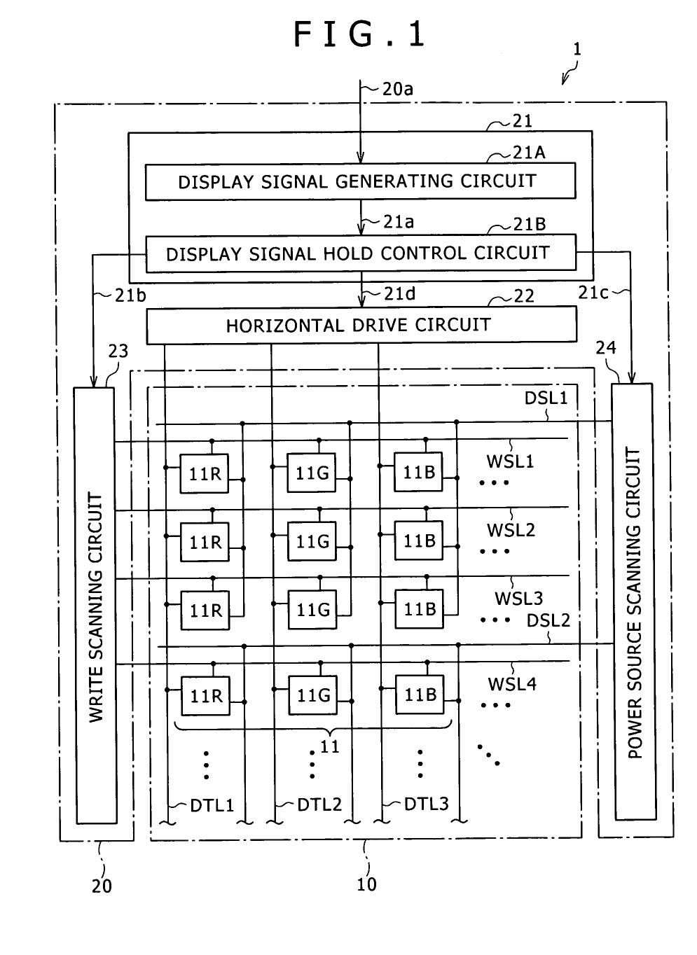

FIG. 1 is a block diagram showing an entire configuration of a display device 1 according to an embodiment of the present invention. The display device 1 includes a display portion 10, and a peripheral circuit 20 (a drive portion) formed in the periphery of the display portion 10. In this case, the display portion 10 and the peripheral circuit 20 are formed on a substrate (not shown), for example, made of a glass, a silicon (Si) wafer or a resin.

In the display portion 10, a plurality of pixels 11 are two-dimensionally disposed in a matrix over an entire surface of the display portion 10. Also, the display portion 10 displays thereon an image, based on a video signal 20a inputted from the outside, in accordance with active matrix drive. Each of the pixels 11 includes a pixel 11R for a red color, a pixel 11G for a green color, and a pixel 11B for a blue color.

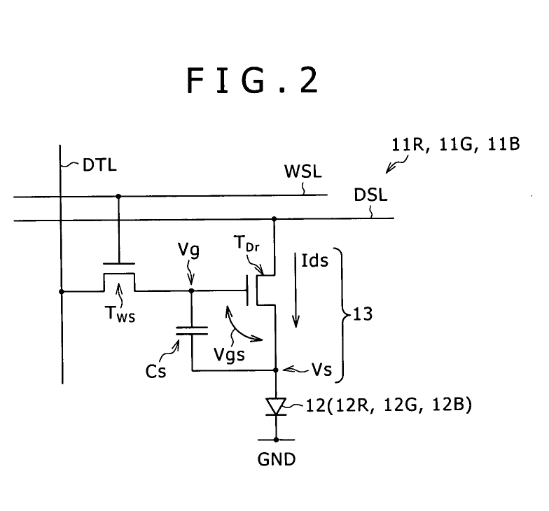

FIG. 2 is a circuit diagram showing an inner configuration of the pixel 11R, the pixel 11G, or the pixel 11B. As shown in FIG. 2, an organic EL element 12R, 12G or 12B (light emitting element), and a pixel circuit 13 are provided within the pixel 11R, 11G or 11B.

Although an illustration is omitted here, the organic EL element 12R, 12G or 12B (hereinafter referred to as “the organic EL element 12R or the like”), for example, has a structure in which an anode, an organic layer and a cathode are laminated in order. The organic layer, for example, has a lamination structure in which a hole injection layer, a hole transport layer, a light emitting layer, and an electron transfer layer are laminated in order from the anode side. In this case, the hole injection layer serves to enhance a hole injection efficiency, and the hole transport layer serves to enhance an efficiency of transport of the holes to the light emitting layer. Also, the light emitting layer emits a light based on recombination between the electron and the hole, and the electron transport layer enhances an efficiency of transport of the electrons to the light emitting layer.

The pixel circuit 13 is composed of a sampling transistor T_{WS} (first transistor), a hold capacitor Cₛ, and a drive transistor T_{Dr} (second transistor), and thus has a 2Tr1C circuit configuration. Each of the sampling transistor T_{WS} and the drive transistor T_{Dr}, for example, is configured in the form of an n-channel MOS type Thin Film Transistor (TFT).

The peripheral circuit 20 has a timing control circuit 21 (control portion), a horizontal drive circuit 22 (third drive portion), a write scanning circuit 23 (first drive portion), and a power source scanning circuit 24 (second drive portion). The timing control circuit 21 includes a display signal generating circuit 21A and a display signal hold control circuit 21B. In addition, gate lines WSLs (first wirings), drain lines DSLs (second wirings), signal lines DTLs (third wirings), and a ground line GND (fourth wiring) are provided in the peripheral circuit 20. One drain line DSL is provided every unit with a plurality of pixel rows (three rows in FIG. 1) as a unit. It should be noted that a ground line is connected to the ground line GND, and a voltage of the ground line is set at a ground voltage (referenced voltage).

The display signal generating circuit 21A generates a display signal 21a in accordance with which an image is displayed on the display portion 10, for example, every one picture (every display of one field) based on the video signal 20a inputted thereto from the outside.

The display signal hold control circuit 21B stores and holds the display signal 21a outputted from the display signal generating circuit 21A in a field memory, for example, composed of a Static Random Access Memory (SRAM) every one picture (every display of one field). The display signal hold control circuit 21B plays a part as well of carrying out control in such a way that the horizontal drive circuit 22 for driving the pixels 11, the write scanning circuit 23 and the power source scanning circuit 24 operate in conjunction with one another. Specifically, the display signal hold control circuit 21B outputs control signals 21b, 21c and 21d to the write scanning circuit 23, the power source scanning circuit 24, and the horizontal drive circuit 22, respectively.

The horizontal drive circuit 22, for example, is composed of a shift register (not shown), and includes signal outputting portions (not shown) in respective stages so as to correspond to columns of the pixels 11, respectively. The horizontal drive circuit 22 can output three kinds of voltages (Vₑᵣₛ (sixth voltage), V_{ofs} (seventh voltage), and V_{sig} (eighth voltage)) in accordance with the control signal 21d outputted from the display signal hold control circuit 21B. Specifically, the horizontal drive circuit 22 regularly supplies the three kinds of voltages (Vₑᵣₛ, V_{ofs} and V_{sig}) to each of the pixels 11 selected by the write scanning circuit 23 through corresponding ones of the signal lines DTLs connected to the columns of the pixels 11 of the display portion 10, respectively.

Here, the voltages Vₑᵣₛ and V_{ofs} are voltages each lower than the threshold voltage Vₑₗ of the organic EL element 12R or the like. Also, the voltage V_{ofs} is the voltage lower than the voltage Vₑᵣₛ. In addition, the voltage V_{sig} has a voltage value corresponding to the video signal 20a. A minimum voltage of the voltage V_{sig} is lower than the voltage V_{ofs}, and a maximum voltage of the voltage V_{sig} is higher than the voltage Vₑᵣₛ.

The write scanning circuit 23, for example, is composed of a shift register (not shown), and includes signal outputting portion (not shown) in respective stages so as to correspond to the rows of the pixels 11, respectively. The write scanning circuit 23 can output three kinds of voltages (Vₒₙ (third voltage), V_{off1} (first voltage), and V_{off2} (second voltage)) in accordance with the control signal 21b outputted from the display signal hold control circuit 21B. Specifically, the write scanning circuit 23 regularly supplies three kinds of voltages Vₒₙ, V_{off1}, and V_{off2}) to each of the pixels 11 as objects of the drive through corresponding ones of the gate lines WSLs connected to the rows of the pixels 11 of the display portion 10, respectively, thereby controlling corresponding ones of the sampling transistors T_{WS} in the pixels 11.

Here, the voltage Vₒₙ is equal to or higher than an ON voltage of the sampling transistor T_{WS}. The voltage Vₒₙ is a voltage which is outputted from the write scanning circuit 23 in a phase of quenching or in a phase of correction for the threshold voltage Vₜₕ. The quenching and the correction for the threshold voltage Vₜₕ will be described later. The voltages V_{off1} and V_{off2} are voltages each lower than the ON voltage of the sampling transistor T_{WS}, and lower than the voltage Vₒₙ. In addition, the voltage V_{off2} is lower than the voltage V_{off1}. The voltage V_{off1} is a voltage which is outputted from the write scanning circuit 23 for each of paragraphs of “Time Period for Pausing of Vₜₕ Correction” and “Time Period for Light Emission” which will be described later. The voltage V_{off2} is a voltage which is outputted from the write scanning circuit 23 for each of paragraphs of “Time Period for Quenching” and “Time Period for Preparation for Vₜₕ Correction” which will be described later.

The power source scanning circuit 24, for example, is composed of a shift register (not shown), and includes signal outputting portions (not shown) in respective stages the number of which is equal to the number of rows contained in each of groups so as to correspond to the groups with a plurality of pixel rows (three rows in FIG. 1) as one group. In other words, in this embodiment, the output stage of the shift register within the power source scanning circuit 24 is shared among a plurality of pixel rows (three rows in FIG. 1), and thus adopts a unit scanning system. For this reason, the number of signal outputting portions within the power source scanning circuit 24 is less as compared with the case where the signal outputting portions are provided in respective stages so as to correspond to the columns of the pixels, respectively.

The power source scanning circuit 24 can output two kinds of voltages Vₛₛ (fourth voltage) and V_{cc} (fifth voltage) in accordance with the control signal 21c outputted from the display signal hold control circuit 21B. Specifically, the power source scanning circuit 24 regularly supplies the two kinds of voltages (Vᵢₙᵢ and Vₛₛ) to each of the pixels 11 as objects of drive through corresponding ones of the drain lines DSLs connected to the row units of the pixels 11 of the display portion 10, respectively, with the three rows as one unit, thereby controlling the light emission and the quenching of corresponding ones of the organic EL elements 12R or the like.

Here, the voltage Vₛₛ is a voltage which is lower than a voltage (Vₑₗ+V_{ca}) obtained by adding the threshold voltage Vₑₗ and the cathode voltage V_{ca} of the organic EL element 12R or the like to each other. Also, a voltage V_{cc} is a voltage more than a voltage (Vₑₗ+V_{ca})

Next, a connection relationship among the constituent elements will be described with reference to FIGS. 1 and 2. The signal lines DTLs (DTL1, DTL2, . . . ) formed so as to extend in the column direction are connected to the signal outputting portions within the horizontal drive circuit 22, respectively, so as to show one-to-one correspondence. Also, drains of the sampling transistors T_{WS} included in the pixels 11 belonging to the respective rows are connected to the signal lines DTLs (DTL1, DTL2, . . . ), respectively, so as to show one-to-one correspondence. In addition, the gate lines WSLs (WSL1, WSL2, . . . ) formed so as to extend in row direction are connected to the signal outputting portions within the write scanning circuit 23, respectively, so as to show one-to-one correspondence. Also, gates of the sampling transistors T_{WS} included in the pixels belonging to the respective columns are connected to the gate lines WSLs (WSL1, WSL2, . . . ), respectively, so as to show one-to-one correspondence. In addition, the drain lines DSLs (DSL1, DSL2, . . . ) formed so as to extend in the row direction are connected to the signal outputting portions within the power source scanning circuit 24, respectively, so as to show one-to-one correspondence. Also, drains of the drive transistors T_{Dr} included in the pixels 11 belonging to the respective units are connected to the drain lines DSLs (DSL1, DSL2, . . . ), respectively. Moreover, in each of the pixels 11R, 11G and 11B, the source of the sampling transistor T_{WS} is connected to each of the gate electrode of the drive transistor T_{Dr}, and one terminal of the hold capacitor C₈. Also, each of the source electrode of the drive transistor T_{Dr}, and the other terminal of the hold capacitor Cₛ is connected to the anode electrode of the organic EL element 12R or the like. In addition, the cathode electrode of the organic EL element 12R or the like is connected to the ground line GND.

Next, an operation (an operation from the quenching to the light emission) of the display device 1 of the embodiment will be described. Even when the I-V characteristics of the organic EL element 12R or the like temporally change, or the threshold voltage Vₜₕ and mobility μ of the drive transistor T_{Dr} temporally change, the emission luminance of the organic EL element 12R or the like has to be held constant without being influenced by these temporal changes. In order to attain this, in the embodiment, an operation for compensating for the change in I-V characteristics of the organic EL element 12R or the like, and an operation for correcting the changes in threshold voltage Vₜₕ and mobility μ of the drive transistor T_{Dr} are incorporated in the display device 1.

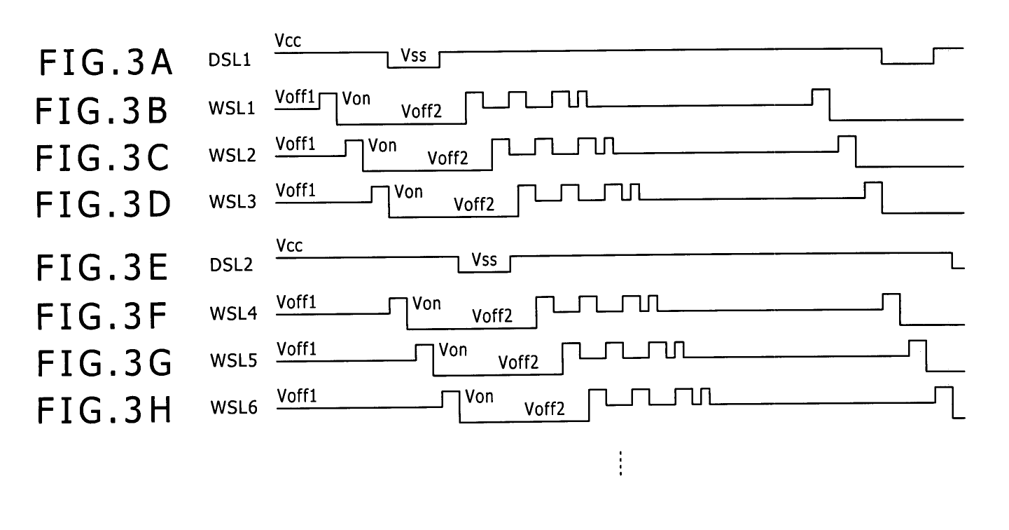

FIGS. 3A to 3H respectively show various kinds of waveforms of the potentials in the display device 1. Specifically, FIGS. 3A to 3H show a situation in which the two kinds of voltages (V_{cc} and Vₛₛ (<V_{c})) are inputted to each of the drain lines DSL1 and DSL2, and the three kinds of voltages (Vₒₙ, V_{off1} (<Vₒₙ), and V_{off2} (<V_{off1})) are applied to each of the gate lines WSL1 to WSL6. As can be seen from FIGS. 3A to 3H, the voltages V_{cc} and Vₛₛ are applied from the drain lines DSLs (DSL1, DSL2, . . . ) to the pixels 11 at common timings every group with a plurality if columns of the pixels (the three columns in FIG. 3) as one group.

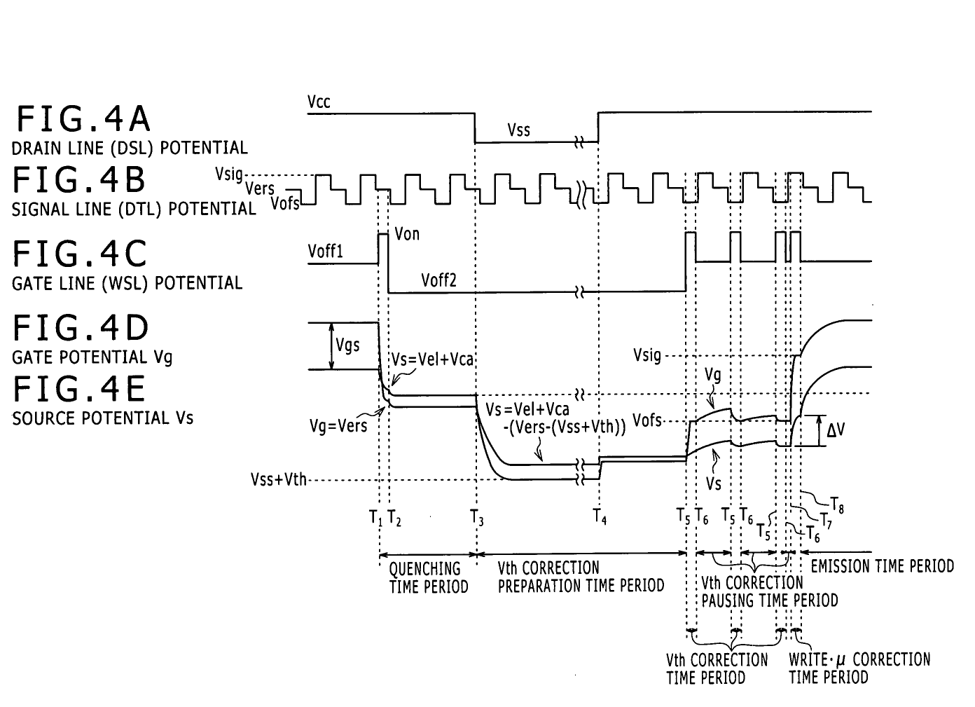

FIGS. 4A to 4E show waveform charts of the voltages applied to one pixel 11 of the display device 1. Specifically, FIGS. 4A to 4E show a situation in which the two kinds of voltages (V_{cc} and Vₛₛ) are applied to the drain line DSL, the three kinds of voltages (V_{sig}, Vₑᵣₛ (<Vₑₗ), and V_{ofs} (<Vₑᵣₛ)) are applied to the signal line DTL, and the three kinds of voltages (Vₒₙ, V_{off1}, and V_{off2}) are applied to the gate line WSL. Moreover, FIGS. 4A to 4E show a situation in which the gate voltage V_{g} and source voltage Vₛ of the drive transistor T_{Dr} momentarily change in accordance with the application of the voltages to the drain line DSL, the signal line DTL, and the gate line WSL. It should be noted that numerical symbol Vₑₗ designates the threshold voltage of the organic EL element 12R or the like.

### (Time Period for Quenching)

Firstly, an operation for quenching the organic EL element 12R or the like is carried out. Specifically, while the voltage of the drain line DSL is held at the voltage V_{cc}, and the voltage of the signal line DTL is held at the voltage Vₑᵣₛ, the write scanning circuit 23 causes the voltage of the gate line WSL to rise from the voltage V_{off1} to the voltage Vₒₙ (time T₁), thereby connecting the gate electrode of the drive transistor T_{Dr} to the signal line DTL. As a result, the voltage of the drive transistor T_{Dr} begins to drop, and the source voltage Vₛ of the drive transistor T_{Dr} also begins to drop through the coupling via the hold capacitor Cₛ. After that, when the gate voltage V_{g} becomes equal to the voltage Vₑᵣₛ and the source voltage Vₛ becomes equal to the voltage (Vₑₗ+V_{ca (V}_{ca} is the cathode voltage of the organic EL element 12R or the like)), so that the organic EL element 12R or the like is quenched, the write scanning circuit 23 causes the voltage of the gate line WSL to drop from the voltage Vₒₙ to the voltage V_{off2} lower than the voltage V_{off1}, thereby making the gate voltage V_{g} of the drive transistor T_{Dr} in the floating state (time T₂).

### (Time Period for Preparation for Vₜₕ Correction)

Next, an operation for preparing for the correction for the threshold voltage Vₜₕ is carried out. Specifically, while the voltage of the gate line WSL is held at the voltage V_{off2}, the power source scanning circuit 24 causes the voltage of the drain line DSL to drop from the voltage V_{cc} to the voltage Vₛₛ (time T₃). As a result, the drain line DSL side of the drive transistor T_{Dr} acts as the source, and thus the current I_{ds} is caused to flow between the drain and the source of the drive transistor T_{Dr}. When the gate voltage V_{g} becomes equal to the voltage (Vₛₛ+Vₜₕ), the flowing of the current I_{ds} stops. At this time, the source voltage Vₛ is equal to the voltage [Vₑₗ+V_{ca}−{Vₑᵣₛ−(Vₛₛ+Vₜₕ)}], and the potential difference V_{gs} is smaller than the threshold voltage Vₜₕ.

Subsequently, the power source scanning circuit 24 causes the voltage of the drain line DSL to rise from the voltage Vₛₛ to the voltage V_{cc} (time T₄). As a result, the current I_{ds} is caused to flow between the drain and the source of the drive transistor T_{Dr}, so that each of the gate voltage V_{g} and the source voltage Vₛ rises due to the capacitive coupling between a parasitic capacitance between the gate and drain of the drive transistor T_{Dr}, and the hold capacitor Cₛ. At this time, the potential difference V_{gs} is still smaller than the threshold voltage Vₜₕ.

### (Time Period for First Vₜₕ Correction)

Next, an operation for correcting the threshold voltage Vₜₕ is carried out. Specifically, while the voltage of the drain line DSL is held at the voltage V_{cc}, and the voltage of the signal line DTL is held at the voltage V_{ofs}, the write scanning circuit 23 causes the voltage of the gate line WSL to rise from the voltage V_{off2} to the voltage Vₒₙ (time T₅). As a result, the current I_{ds} is caused to flow between the drain and source of the drive transistor T_{Dr}, so that each of the gate voltage V_{g} and the source voltage Vₛ rises due to the capacitive coupling between the parasitic capacitance between the gate and drain of the drive transistor T_{Dr}, and the hold capacitor Cₛ. Here, the potential difference V_{gs} becomes large because the capacitance of the hold capacitor Cₛ is sufficiently smaller than that of the element capacitor of the organic EL element 12R or the like, and a rise amount of source voltage Vₛ is sufficiently smaller than that of gate voltage V_{g}. Also, in a stage in which the potential difference V_{gs} becomes larger than the threshold voltage Vₜₕ, the write scanning circuit 23 causes the voltage of the gate line WSL to drop from the voltage Vₒₙ to the voltage V_{off1} (time T₆). As a result, the gate voltage V_{g} of the drive transistor T_{Dr} becomes the floating state, and thus the correction for the threshold voltage Vₜₕ is temporarily stopped.

### (Time Period for Pausing of First Vₜₕ Correction)

For a time period for the pausing of the correction for the threshold voltage Vₜₕ, for example, the operation for sampling the voltage of the signal line DTL is carried out in another row (pixels) different from the row (pixel) for which the last correction for the threshold voltage Vₜₕ is carried out. Note that, at this time, since the source voltage Vₛ is lower than the voltage (V_{ofs}−Vₜₕ) in the row (pixel) for which the last correction for the threshold voltage Vₜₕ is carried out, even for the time period for the pausing of the correction for the threshold voltage Vₜₕ, the current I_{ds} is caused to flow between the drain and source of the drive transistor T_{Dr} in the row (pixels) for which the last correction for the threshold voltage Vₜₕ is carried out. As a result, the source voltage Vₛ rises, and the gate voltage V_{g} also rises due to the coupling via the hold capacitor Cₛ.

### (Time Period for Second Vₜₕ Correction)

After completion of the time period for the pausing of the correction for the threshold voltage Vₜₕ, the operation for correcting the threshold voltage Vₜₕ is carried out again. Specifically, while the voltage of the signal line DTL is held at the voltage V_{ofs}, and the correction for the threshold voltage Vₜₕ is possible, the write scanning circuit 23 causes the voltage of the gate line WSL to rise from the voltage V_{off1} to the voltage Vₒₙ (time T₅), thereby connecting the gate electrode of the drive transistor T_{Dr} to the signal line DTL. At this time, when the source voltage Vₛ is lower than the voltage (V_{ofs}−Vₜₕ) (when the operation for correcting the threshold voltage Vₜₕ is not yet completed), the current I_{ds} is continuously caused to flow between the drain and source of the drive transistor T_{Dr} until the drive transistor T_{Dr} is cut off (until the potential difference V_{gs} becomes equal to the threshold Vₜₕ). After that, the write scanning circuit 23 causes the voltage of the gate line WTL to drop from the voltage Vₒₙ to the voltage V_{off1} (time T₆) before the horizontal drive circuit 22 switches the voltage of the signal line DTL from the voltage V_{ofs} to the voltage V_{sig}. As a result, since the gate voltage V_{g} of the drive transistor T_{Dr} becomes the floating state, the potential difference V_{gs} can be kept constant irrespective of the magnitude of the voltage of the signal line DTL.

It is noted that although for the time period for the correction for the threshold voltage Vₜₕ, the operation for correcting the threshold voltage Vₜₕ ends, when the hold capacitor Cₛ is charged with the electricity from the threshold voltage Vₜₕ, and thus the potential difference V_{gs} becomes equal to the threshold voltage Vₜₕ, when the potential difference V_{gs} does not reach the threshold voltage Vₜₕ, the operation for correcting the threshold voltage Vₜₕ and the operation for pausing the correction for the threshold voltage Vₜₕ are repetitively carried out until the potential difference V_{gs} reaches the threshold voltage Vₜₕ.

### (Time Period for Write·μ Correction)

The write operation and the operation for correcting a mobility μ are carried out after end of the time period for the pausing of the correction for the threshold voltage Vₜₕ. Specifically, while the voltage of the signal line DTL is held at the voltage V_{sig}, the write scanning circuit 23 causes the voltage of the gate line WSL to rise from the voltage V_{off1} to the voltage Vₒₙ (time T₇), thereby connecting the gate electrode of the drive transistor T_{Dr} to the signal line DTL. As a result, the gate voltage V_{g} of the drive transistor T_{Dr} becomes equal to the voltage V_{sig}. At this time, the anode voltage of the organic EL element 12R or the like is still lower than the threshold voltage Vₑₗ of the organic EL element 12R or the like in this stage, and thus the organic EL element 12R or the like is cut off. For this reason, the current I_{ds} is caused to flow through the element capacitor of the organic EL element 12R or the like, so that the element capacitor is charged with the electricity. Therefore, the source voltage Vₛ rises by ΔV, and the potential difference V_{gs} soon becomes equal to the voltage (V_{sig}+Vₜₕ−ΔV). In such a manner, the operation for correcting the mobility μ is carried out concurrently with the write operation.

### (Light Emission)

Finally, the write scanning circuit 23 causes the voltage of the gate line WSL to drop from the voltage Vₒₙ to the voltage V_{off1} (time T₈). As a result, the gate voltage V_{g} of the drive transistor T_{Dr} becomes the floating state, and thus the current I_{ds} is caused to flow between the drain and the source of the drive transistor T_{Dr}, so that the source voltage Vₛ rises. As a result, the organic EL element 12R or the like emits a light with a desired luminance.

In the display device 1 of the embodiment, the pixel circuit 13 is controlled so as to be turned ON or OFF in each of the pixels 11 in the manner as described above, and thus the drive current is injected into the organic EL element 12R or the like in each of the pixels 11, whereby the hole and the electron are recombined with each other to emit a light. The resulting light is multiply reflected between the anode electrode and the cathode electrode to be transmitted through the anode electrode or the like, thereby being taken out to the outside. As a result, an image is displayed on the display portion 10.

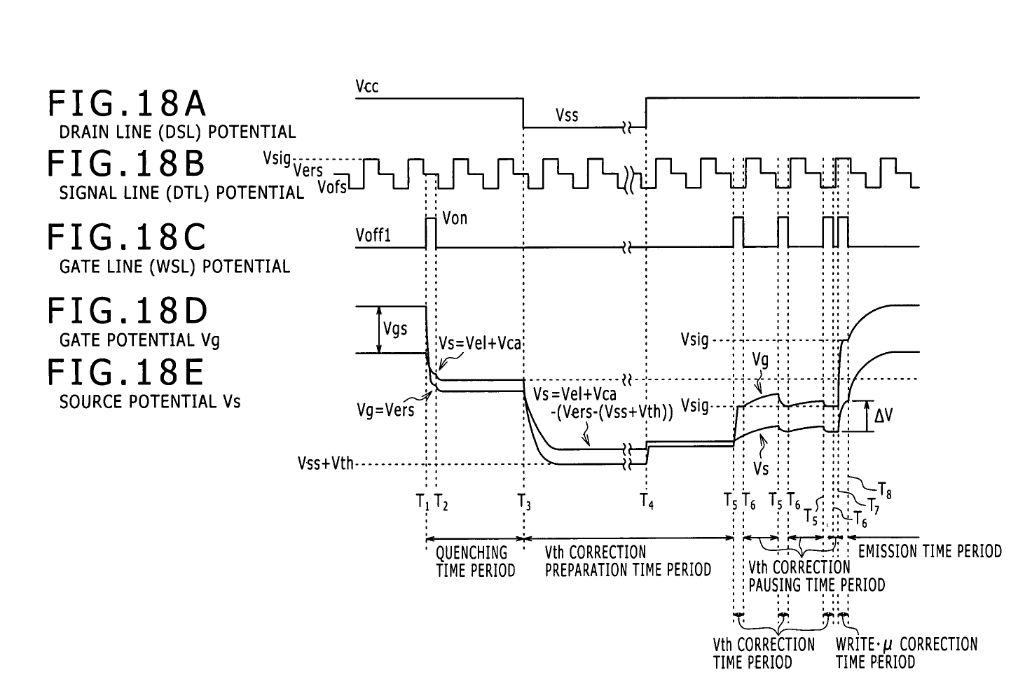

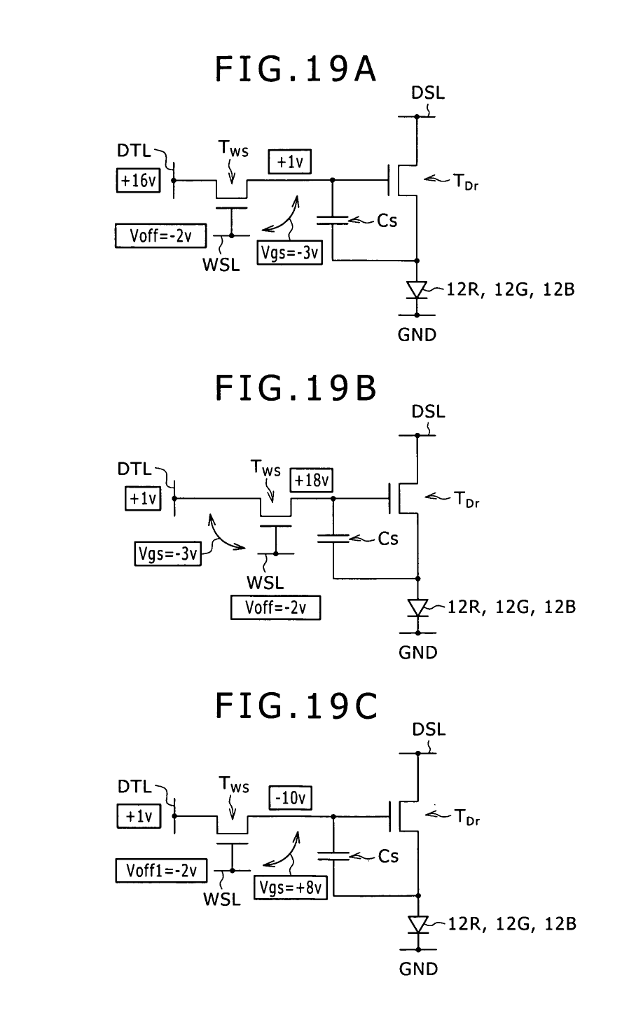

Now, in the case where the light is emitted in accordance with the drive procedure as shown in FIGS. 18A to 18E, in order that the potential difference V_{gs} in the drive transistor T_{Dr} may exceed the threshold voltage Vₜₕ while the gate voltage V_{g} is held at the voltage V_{ofs} for the time period for the correction for the threshold voltage Vₜₕ, the gate voltage V_{g} of the drive transistor T_{Dr} has to be made sufficiently low before start of the correction for the threshold voltage Vₜₕ. For example, when the gate voltage V_{g} of the drive transistor T_{Dr} right before start of the correction for the threshold voltage Vₜₕ is set at +1 V, in order to perfectly turn OFF the sampling transistor T_{WS} (in order to set the gate-to-source potential difference V_{gs} of the sampling transistor T_{WS} at about −3 V) as shown in FIG. 19A for the time period for the pausing of the correction for the threshold voltage Vₜₕ, the voltage V_{off} of the gate line WSL has to be set at −2 V. When the voltage V_{off} of the gate line WSL is set at −2 V in such a manner, as shown in FIG. 19B, the potential difference V_{gs} becomes −3 V for the time period as well for light emission. As a result, the sampling transistor T_{WS} can be perfectly turned OFF.

However, since for the time period for the preparation for the correction for the threshold voltage Vₜₕ, as shown in FIG. 19C, the potential V_{gs} in the sampling transistor T_{WS} becomes +8 V, the sampling transistor T_{WS} may not be perfectly turned OFF, so that the leakage current is caused to flow between the drain and source of the sampling transistor T_{WS}. As a result, the gate voltage V_{g} of the drive transistor T_{Dr} right before start of the correction for the threshold voltage Vₜₕ does not become sufficiently low, and thus the potential difference V_{gs} in the drive transistor T_{Dr} may become lower than the threshold voltage Vₜₕ for the time period for the correction for the threshold voltage Vₜₕ in some cases. Therefore, in this case, there is caused a problem that the threshold voltage Vₜₕ may not be corrected in the subsequent process.

On the other hand, in the display device 1 of the embodiment, as shown in FIGS. 4A to 4E, for the time period for the preparation for the correction for the threshold voltage Vₜₕ, the voltage of the gate line WSL is held at the voltage V_{off2} lower than the voltage V_{off1} (the voltage V_{off1} in FIG. 18C) set for the time period for light emission or the time period for the pausing of the correction for the threshold voltage Vₜₕ. As a result, the gate-to-source potential difference V_{gs} in the sampling transistor T_{WS} can be made small as compared with the case where the voltage of the gate line WSL is held at the voltage V_{off1} (the voltage V_{off1} in FIG. 18C) for the time period for the preparation for the correction for the threshold voltage Vₜₕ.

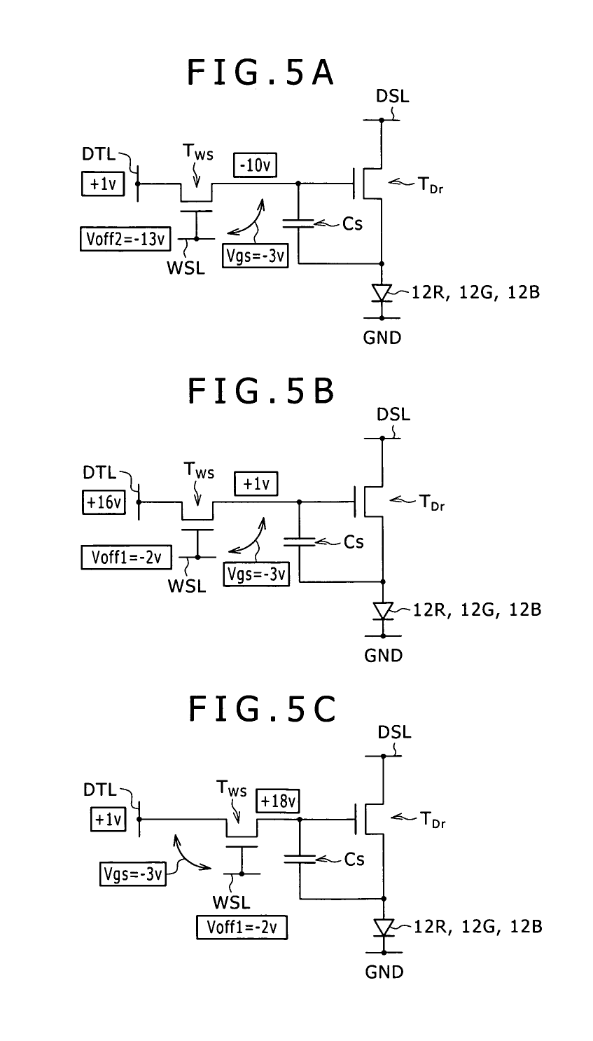

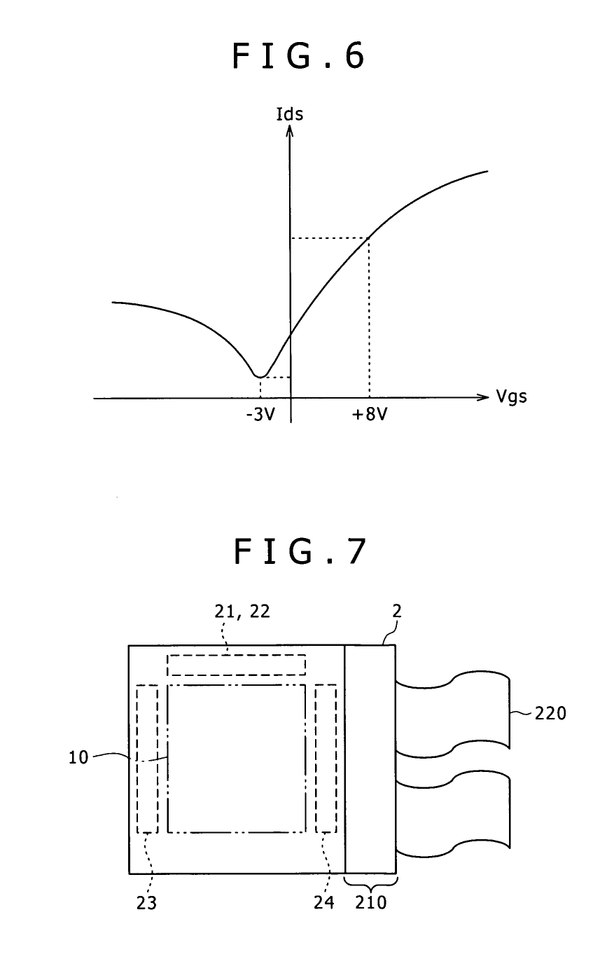

For example, when as shown in FIG. 5A, the voltage V_{off2} of the gate line WSL is set at −13 V for the time period for the preparation for the correction for the threshold voltage Vₜₕ, since the potential difference V_{gs} in the sampling transistor T_{WS} becomes −3 V, the sampling transistor T_{WS} can be perfectly turned OFF. As a result, since the leakage current is hardly caused to flow between the drain and source of sampling transistor T_{WS}, the gate voltage V_{g} of the drive transistor T_{Dr} right before start of the correction for the threshold voltage Vₜₕ becomes sufficiently low. Thus, for the time period for the correction for the threshold voltage Vₜₕ, the potential difference V_{gs} in the drive transistor T_{Dr} reliably exceeds the threshold voltage Vₜₕ. As a result, the possibility that the uniformity of the picture is impaired can be removed because the threshold voltage Vₜₕ can be reliably corrected in the subsequent process, and thus there is no dispersion of the emission luminances of the organic EL elements.

It is noted that since for the time period for the pausing of the correction for the threshold voltage Vₜₕ, as shown in FIG. 5B, the voltage V_{off1} of the gate line WSL is set at −2 V higher than the voltage V_{off2}, the potential difference V_{gs} in the sampling transistor T_{WS} becomes −3 V, and thus the sampling transistor T_{WS} can be perfectly turned OFF. In addition, since when the voltage V_{off1} is set at −2 V, even for the time period for the light emission, as shown in FIG. 5C, the potential difference V_{gs} becomes −3 V, the sampling transistor T_{WS} can be perfectly turned OFF.

### (Module)

The display device 1 of the embodiment, for example, is incorporated as a module shown in FIG. 7 in various kinds of electronic apparatuses typified by first to fifth examples of an embodiment of an electronic apparatus which will be described later. This module, for example, is obtained as follows. That is to say, an area 210 exposed from a member (not shown) with which a display portion 10 is sealed is provided in one side of a substrate 2. Also, the wirings of the timing control circuit 21, the horizontal drive circuit 22, the write scanning circuit 23, and the power source scanning circuit 24 are made to extend therefrom to form outside connection terminals (not shown) in the exposed area 210. In this case, a Flexible Printed Circuit (FPC) board 220 for input/output of signals may be provided in the outside connection terminals.

### (Electronic Apparatus)

The display device 1 according to the embodiment of the present invention described above can be applied to display devices, of electronic apparatuses in all the fields, in each of which a video signal inputted from the outside to the electronic apparatus, or a video signal generated inside the electronic apparatus is displayed in the form of an image or a video image. These electronic apparatuses are typified by various kinds of electronic apparatuses such as a television set, a digital camera, a notebook-size personal computer, mobile terminal equipment such as a mobile phone, and a video camera.

An electronic apparatus according to an embodiment of the present invention includes the display device 1. Here, the display device 1 includes the display portion 10, the write scanning circuit 23, the power source scanning circuit 24, and the horizontal drive circuit 22. The display portion 10 includes a plurality of gate lines WSLs and a plurality of drain lines DSLs each disposed in rows, respectively, a plurality of signal lines DTLs disposed in columns, respectively, and a plurality of organic EL elements 12R, 12G and 12B, and a plurality of pixel circuits 13 each disposed in a matrix. The write scanning circuit 23 successively applies the selection pulse containing therein the voltage V_{off1}, the voltage V_{off2} and the voltage Vₒₙ to a plurality of gate lines WSLs. The power source scanning circuit 24 successively applies the current control pulse in accordance with which the transient current is caused to flow through the pixel circuit 13 to a plurality of drain lines DSLs. Also, the horizontal drive circuit 22 applies the signal pulse containing therein the signal potential corresponding to the video signal 20a to each of a plurality of signal lines DTLs. In this case, the voltage V_{off1}, the voltage V_{off2} and the voltage Vₒₙ contained in the selection pulse have the relationship of the voltage Vₒₙ>the voltage V_{off1}>the voltage V_{off2}. The pixel circuit 13 includes the sampling transistor T_{WS} for sampling the signal pulse, and the drive transistor T_{Dr} for driving the organic EL element 12R or the like. The write scanning circuit 23 applies the voltage V_{off2} to corresponding one of a plurality of gate lines WSLs for the time period for which corresponding one of the organic EL elements 12R, 12G and 12B is quenched and before start of correction for the threshold voltage Vₜₕ of corresponding one of the drive transistors T_{Dr}. Also, the power source scanning circuit 24 applies the current control pulse to corresponding one of a plurality of drain lines DSLs while the write scanning circuit 23 applies the second voltage to corresponding one of a plurality of gate lines WSLs.

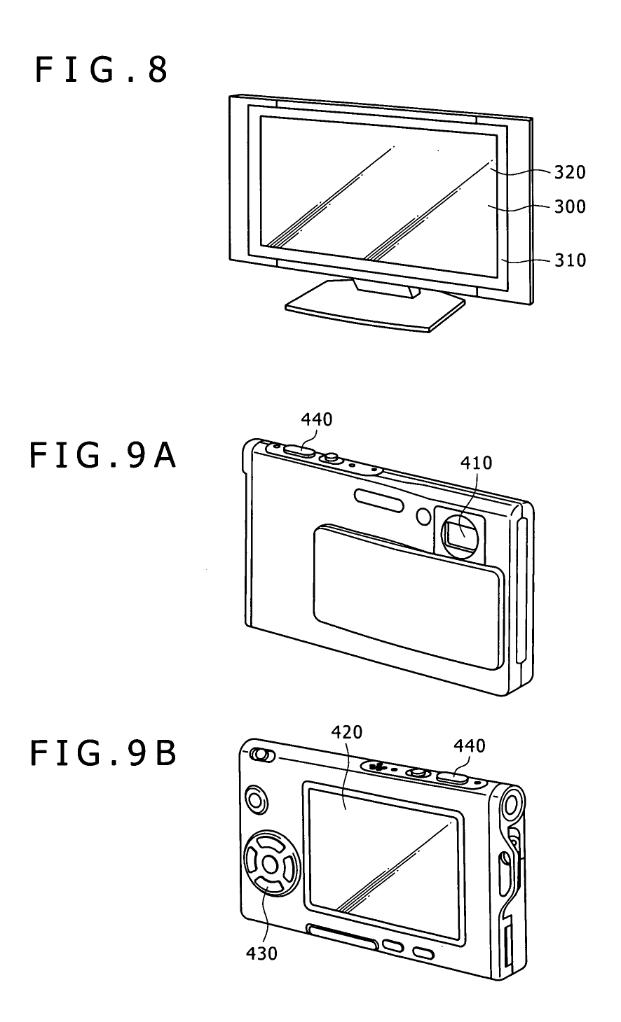

Hereinafter, first to fifth examples of the embodiment of the electronic apparatus including the display device 1 described above will be described with reference to FIG. 8 to FIGS. 12A to 12G.

### FIRST EXAMPLE

FIG. 8 is a perspective view showing an exterior appearance of a television set as a first example of the embodiment of the electronic apparatus. The television set of the first example, for example, includes an image display screen portion 300 composed of a front panel 310 and a filter glass 320. Also, the image display screen portion 300 is composed of the display device 1 of the embodiment described above.

### SECOND EXAMPLE

FIGS. 9A and 9B are respectively perspective views each showing an exterior appearance of a digital camera as a second example of the embodiment of the electronic apparatus. The digital camera of the second example, for example, includes a light emitting portion 410 for flash, a display portion 420, a menu switch 430, and a shutter button 440. Also, the display portion 420 is composed of the display device 1 of the embodiment described above.

### THIRD EXAMPLE

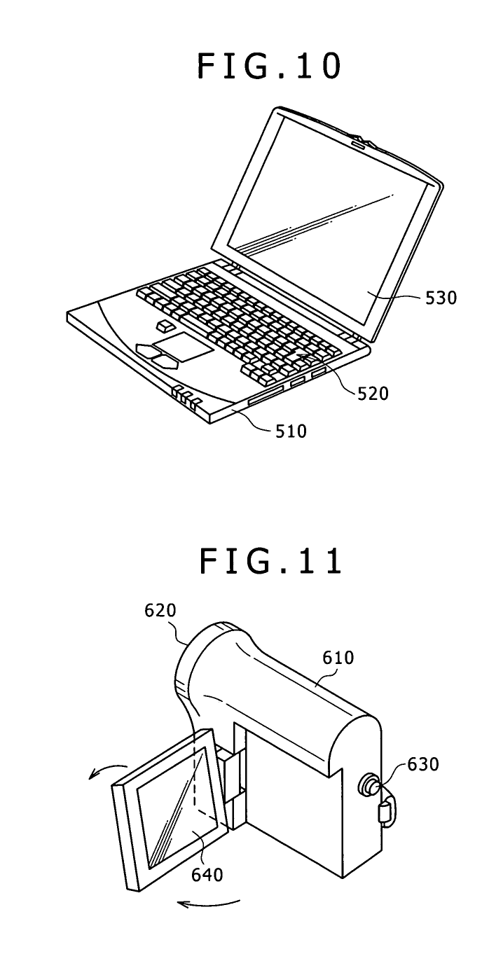

FIG. 10 is a perspective view showing an exterior appearance of a notebook-size personal computer as a third example of the embodiment of the electronic apparatus. The notebook-size personal computer of the third example, for example, includes a main body 510, a keyboard 520 which is manipulated when characters or the like are inputted, and a display portion 530 for displaying thereon an image. Also, the display portion 530 is composed of the display device 1 of the embodiment described above.

### FOURTH EXAMPLE

FIG. 11 is a perspective view showing an exterior appearance of a video camera as a fourth example of the embodiment of the electronic apparatus. The video camera of the fourth example, for example, includes a main body portion 610, a lens 620 which captures an image of a subject and which is provided on a front side surface of the main body portion 610, a start/stop switch 630 which is manipulated when an image of a subject is captured, and a display portion 640. Also, the display portion 640 is composed of the display device 1 of the embodiment described above.

### FIFTH EXAMPLE

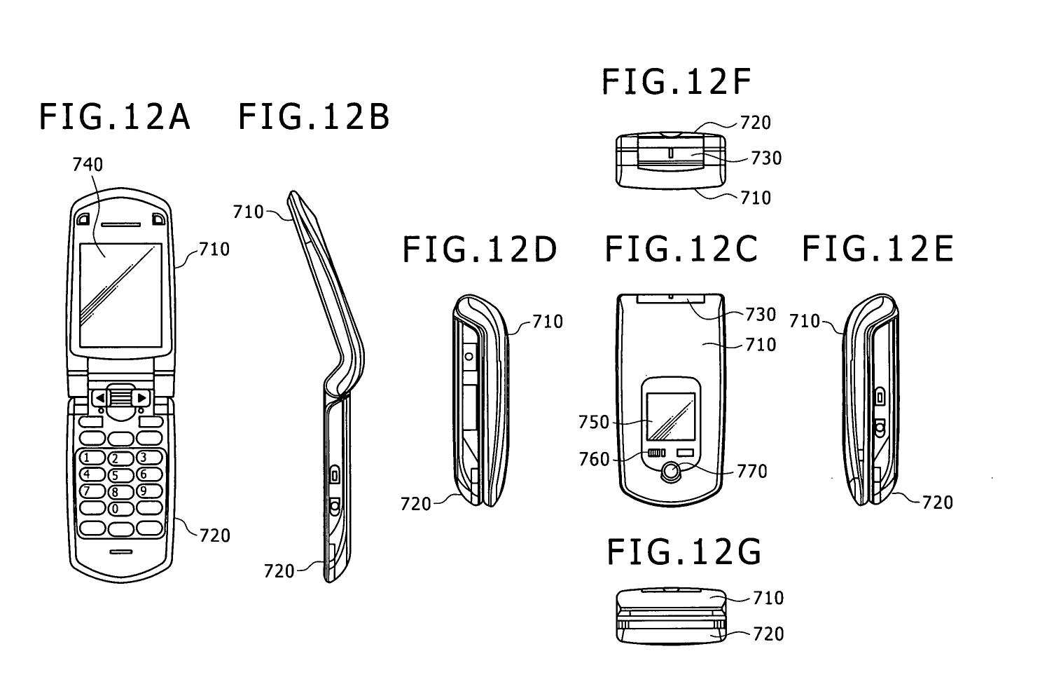

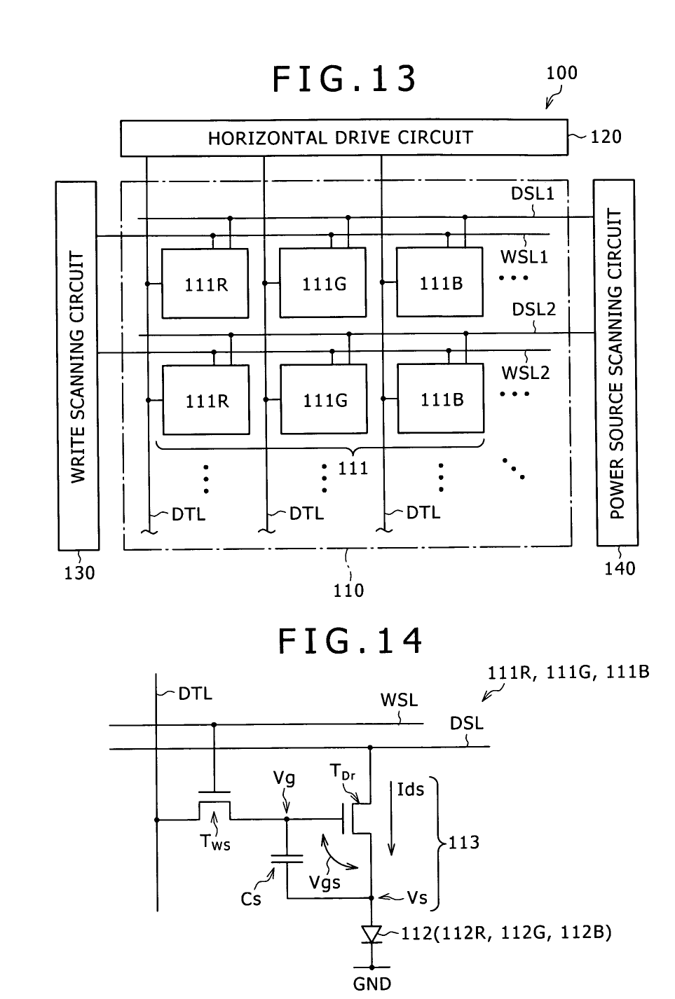

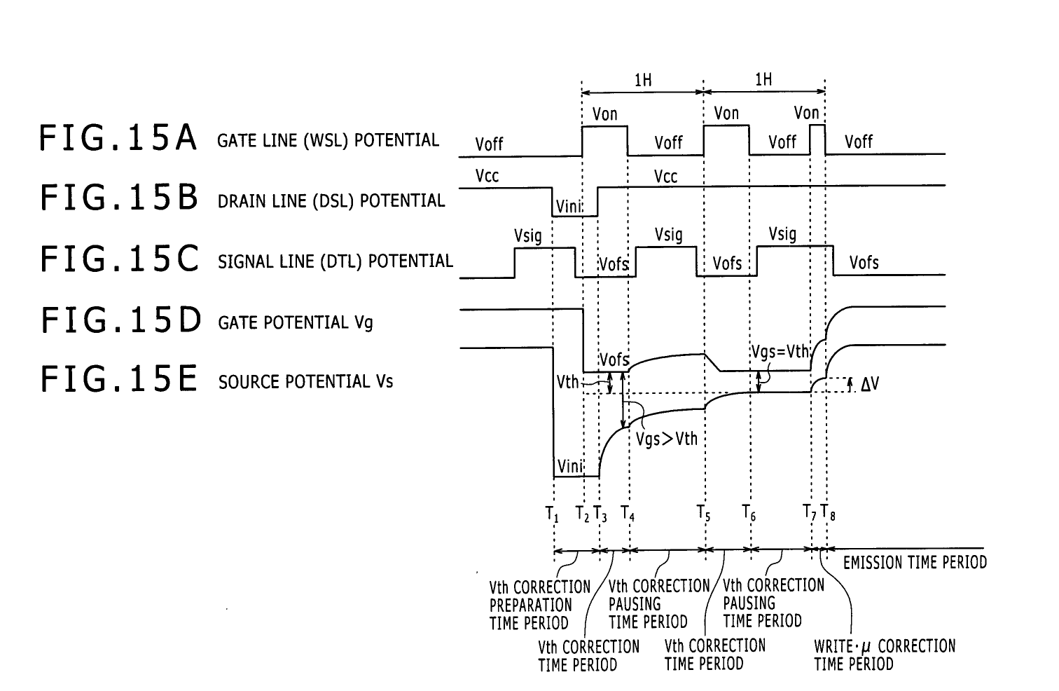

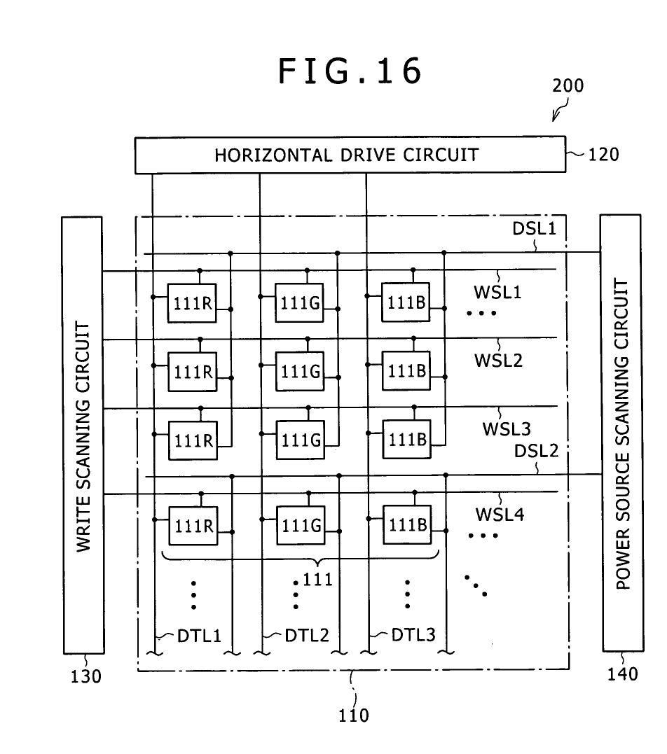

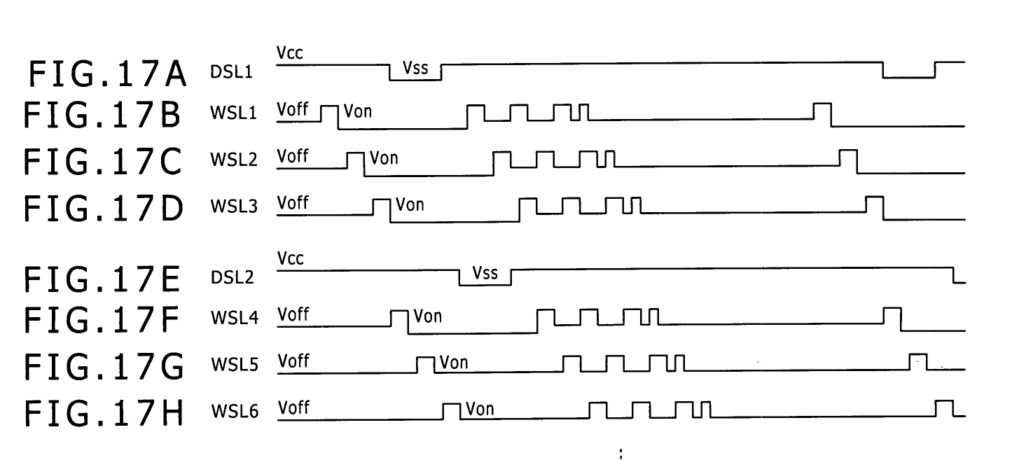

FIGS. 12A to 12G are respectively views each showing an exterior appearance of a mobile phone as a fifth example of the embodiment of the electronic apparatus. The mobile phone, for example, is constructed by connecting an upper chassis 710 and a lower chassis 720 to each other through a connection portion (a hinge portion in this case) 730. The mobile phone includes a display portion 740, a sub-display portion 750, a picture light 760, and a camera 770. Also, the display portion 740 or the sub-display portion 750 is composed of the display device 1 of the embodiment described above.

Although the present invention has been described so far by giving the embodiments and the examples thereof, the present invention is by no means limited to the embodiments and the examples thereof, and various kinds of changes can be made.

For example, in each of the embodiments and the examples thereof, the description has been given with respect to the case where the display device 1 is of the active matrix type, the configuration of the pixel circuit 13 for the active matrix drive is by no means limited to one which has been described in each of the embodiments and the examples thereof. Thus, an element capacitor or a transistor may also be added to the pixel circuit 13 as may be necessary. In this case, in addition to the horizontal drive circuit 22, write scanning circuit 23 and power source scanning circuit 24 described above, a necessary drive circuit may also be added in accordance with the change in configuration of the pixel circuit 13.

In addition, although in each of the embodiments and the examples thereof, the signal hold control circuit 21B controls the operation for driving the horizontal drive circuit 22, the write scanning circuit 23 and the power source scanning circuit 24, any other suitable circuit may also control the drive operation therefor. In addition, the operation for controlling the horizontal drive circuit 22, the write scanning circuit 23 and the power source scanning circuit 24 may be carried out by either the hardware (circuit) or the software (program).

The present application contains subject matter related to that disclosed in Japanese Priority Patent Application JP 2008-171825 filed in the Japan Patent Office on Jun. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display device, comprising:
a display portion including a plurality of first wirings and a plurality of second wirings each disposed in rows, respectively, a plurality of third wirings disposed in columns, respectively, and a plurality of light emitting elements and a plurality of pixel circuits each disposed in a matrix;
a first drive portion for successively applying a selection pulse containing a first voltage, a second voltage and a third voltage to said plurality of first wirings;
a second drive portion for successively applying a current control pulse in accordance with which a transient current is caused to flow through the pixel circuit to said plurality of second wirings; and
a third drive portion for applying a signal pulse containing a signal potential corresponding to a video signal to each of said plurality of third wirings;
wherein the first voltage, the second voltage and the third voltage contained in the selection pulse have a relationship of the third voltage>the first voltage>the second voltage;
the pixel circuit includes a first transistor for sampling the signal pulse, and a second transistor for driving the light emitting element;
said first drive portion applies the second voltage to corresponding one of said plurality of first wirings for a time period for which corresponding one of said light emitting elements is quenched and before start of correction for a threshold voltage of corresponding one of said second transistors; and
said second drive portion applies the current control pulse to corresponding one of said plurality of second wirings while said first drive portion applies the second voltage to corresponding one of said plurality of first wirings.

2. The display device according to claim 1, wherein said first drive portion applies the first voltage to the corresponding one of aid plurality of first wirings for a time period for which the correction for the threshold voltage of said second transistor is paused, and after start of the correction for the threshold voltage of said second transistor of a time period for which said light emitting element emits a light, and the time period for which said light emitting element is quenched.

3. The display device according to claim 1, wherein in said plurality of second wirings, one second wiring is provided every plural rows.

4. A method of driving a display device including:
a display portion including a plurality of first wirings and a plurality of second wirings each disposed in rows, respectively, a plurality of third wirings disposed in columns, respectively, and a plurality of light emitting elements and a plurality of pixel circuits each disposed in a matrix;
a first drive portion for successively applying a selection pulse containing a first voltage, a second voltage and a third voltage to the plurality of first wirings;
a second drive portion for successively applying a current control pulse in accordance with which a transient current is caused to flow through the pixel circuit to said plurality of second wirings; and
a third drive portion for applying a signal pulse containing a signal potential corresponding to a video signal to each of said plurality of third wirings;
the first voltage, the second voltage and the third voltage contained in the selection pulse having a relationship of the third voltage>the first voltage>the second voltage;
the pixel circuit including a first transistor for sampling the signal pulse, and a second transistor for driving the light emitting element;
wherein the method of driving a display device comprising the step of causing said first drive portion to apply the second voltage to corresponding one of said plurality of first wirings for a time period for which corresponding one of said light emitting elements is quenched and before start of correction for a threshold voltage of corresponding one of said second transistors; and said second drive portion is caused to apply the current control pulse to corresponding one of said plurality of second wirings while said first drive portion is caused to apply the second voltage to corresponding one of said plurality of first wirings.

5. An electronic apparatus, comprising:
a display device
said display device including
a display portion having a plurality of first wirings and a plurality of second wirings each disposed in rows, respectively, a plurality of third wirings disposed in columns, respectively, and a plurality of light emitting elements and a plurality of pixel circuits each disposed in a matrix;
a first drive portion for successively applying a selection pulse containing a first voltage, a second voltage and a third voltage to said plurality of first wirings;
a second drive portion for successively applying a current control pulse in accordance with which a transient current is caused to flow through the pixel circuit to said plurality of second wirings; and
a third drive portion for applying a signal pulse containing a signal potential corresponding to a video signal to each of said plurality of third wirings;
wherein the first voltage, the second voltage and the third voltage contained in the selection pulse have a relationship of the third voltage>the first voltage>the second voltage;
the pixel circuit has a first transistor for sampling the signal pulse, and a second transistor for driving the light emitting element;
said first drive portion applies the second voltage to corresponding one of said plurality of first wirings for a time period for which corresponding one of said light emitting elements is quenched and before start of correction for a threshold voltage of corresponding one of said second transistors; and
said second drive portion applies the current control pulse to corresponding one of said plurality of second wirings while said first drive portion applies the second voltage to corresponding one of said plurality of first wirings.

6. The electronic apparatus according to claim 5, wherein said first drive portion applies the first voltage to the corresponding one of aid plurality of first wirings for a time period for which the correction for the threshold voltage of said second transistor is paused, and after start of the correction for the threshold voltage of said second transistor of a time period for which said light emitting element emits a light, and the time period for which said light emitting element is quenched.

7. The electronic apparatus according to claim 5, wherein in said plurality of second wirings, one second wiring is provided every plural rows.

8. A display device, comprising:
display means including a plurality of first wirings and a plurality of second wirings each disposed in rows, respectively, a plurality of third wirings disposed in columns, respectively, and a plurality of light emitting elements and a plurality of pixel circuits each disposed in a matrix;
first drive means for successively applying a selection pulse containing a first voltage, a second voltage and a third voltage to said plurality of first wirings;
second drive means for successively applying a current control pulse in accordance with which a transient current is caused to flow through the pixel circuit to said plurality of second wirings; and
third drive means for applying a signal pulse containing a signal potential corresponding to a video signal to each of said plurality of third wirings;
wherein the first voltage, the second voltage and the third voltage contained in the selection pulse have a relationship of the third voltage>the first voltage>the second voltage;
the pixel circuit includes a first transistor for sampling the signal pulse, and a second transistor for driving the light emitting element;
said first drive means applies the second voltage to corresponding one of said plurality of first wirings for a time period for which corresponding one of said light emitting elements is quenched and before start of correction for a threshold voltage of corresponding one of said second transistors; and
said second drive means applies the current control pulse to corresponding one of said plurality of second wirings while said first drive means applies the second voltage to corresponding one of said plurality of first wirings.

9-21. (canceled)
